(19) United States
(12) Patent Application Publication
(10) Pub. No.: US 2023/0180200 A1
(43) Pub. Date: Jun. 8, 2023

(54) APPROACHES TO SELF-CLUSTERING RESOURCE BLOCKS FOR IMPROVED NOISE ESTIMATION THROUGH IMBALANCE DETECTION

(71) Applicant: ZEKU, INC., Palo Alto, CA (US)

(72) Inventors: Yanming WANG, San Diego, CA (US); Chengzhi LI, San Diego, CA (US); Bin LIU, San Diego, CA (US)

(21) Appl. No.: 18/066,186

(22) Filed: Dec. 14, 2022

Related U.S. Application Data
(63) Continuation of application No. PCT/US2021/016173, filed on Feb. 2, 2021.
(60) Provisional application No. 63/039,268, filed on Jun. 15, 2020.

(51) Int. Cl. H04W 72/0453; H04L 5/00

(52) U.S. Cl. CPC H04W 72/0453; H04L 5/0057

(57) ABSTRACT

Introduced here are processes in which noise covariance is estimated across resource blocks that have similar distributions of noise. These processes result in more accurate estimation of noise occurring in a given channel, as accuracy can be improved by increasing the number of resource blocks being examined while also identifying and then filtering those resource blocks that are contaminated with interference. At a high level, these processes represent an automated approach to detecting imbalance between resource blocks with noise and resource blocks with interference in addition to noise and then forming clusters of resource blocks having similar characteristics to provide more samples that can be used in estimating noise covariance.

### CROSS-REFERENCE TO RELATED APPLICATIONS

This application is a continuation of PCT application No. PCT/US2021/016173, filed Feb. 2, 2021, which claims priority to U.S. Provisional Application No. 63/039,268, titled “Self-Clustering Noise Estimation with Interference Imbalance Detection” and filed on Jun. 15, 2020, both of which are incorporated herein by reference in its entirety.

### TECHNICAL FIELD

Various embodiments concern approaches to estimating the noise experienced by a wireless communication system.

### BACKGROUND

In the field of wireless communication, estimating noise covariance is an important step when designing receivers to ensure that incoming signals are properly demodulated and decoded. Noise covariance is estimated by comparing an incoming signal (referred to as a “reference signal”) on a reference tone and a corresponding estimated channel in that reference tone. From the perspective of the demapper, the reference signal can be either a demodulation reference signal (DMRS) or cell-specific reference signal (CRS). Assume, for example, that a received signal in a reference tone can be represented follows:

y=Hx+n, Eq. 1

where y is a vector with dimensions of nᵣ×1 that is representative of the received signal and n is a vector with dimensions of nᵣ×1 that is representative of the noise. Meanwhile, x is the transmitted reference signal which is known to the receiver, and H is a channel matrix having dimensions of nᵣ×nₜ, where nₜ is the number of ports of the reference signal. In the case of a multi-user (MU) multiple-input, multiple-output (MIMO) device, nₜ could be larger than the rank in transmitted data. Assuming that Ĥ is the estimated channel, the estimated noise can be represented as follows:

\hat{n}=y−Ĥx, Eq. 2

and the estimated noise covariance becomes

\hat{R}_{n,n}=\hat{n}×\hat{n}^{H}. Eq. 3

There are generally multiple reference tones within a resource block (RB). In 5G New Radio (NR), for example, each RB included in the physical broadcast channel (PBCH) and physical download control channel (PDCCH) contains three reference tones. Meanwhile, in the physical downlink shared channel (PDSCH), each RB may contain four or six reference tones depending on type (e.g., DMRS, CRS) of the corresponding reference signals.

### BRIEF DESCRIPTION OF THE DRAWINGS

FIG. 1 includes a high-level diagram that illustrates the two PDSCH-DMRS configurations within an RB.

FIG. 2 includes a high-level illustration of the workflow implemented by a receiver of a wireless communication system.

FIG. 3 illustrates how interference may occur in the middle of bandwidth of a channel.

FIG. 4 illustrates how imbalance in interference has caused the RBs of a given channel to be sorted into three clusters.

FIG. 5 illustrates the benefits of the approach introduced here through a simulation using the example channels shown in FIGS. 2-3.

FIG. 6 demonstrates how the RBs included in a channel may be sorted into four clusters following a first iteration of the approach.

FIG. 7 depicts a flow diagram of a process for distinguishing RBs having dissimilar noise distributions.

FIG. 8 depicts a flow diagram of another process for sorting RBs include clusters based on the amount of interference contained therein.

FIG. 9 depicts a flow diagram of a process for combining non-adjacent clusters of RBs having comparable noise distributions.

FIG. 10 includes a high-level block diagram that illustrates an example of a computing system in which at least some operations described herein can be implemented.

Various features of the technology described herein will become more apparent to those skilled in the art from a study of the Detailed Description in conjunction with the drawings. Embodiments are illustrated by way of example and not limitation in the drawings, in which like references may indicate similar elements. While the drawings depict various embodiments for the purpose of illustration, those skilled in the art will recognize that alternative embodiments may be employed without departing from the principles of the technology. Accordingly, while specific embodiments are shown in the drawings, the technology is amenable to various modifications.

### DETAILED DESCRIPTION

For a wireless communication system (also referred to as a “digital communication system”), the maximum likelihood that a receiver will detect a signal originating from a source is based on the conditional probability given the measurement of the signal at the demodulator. This is shown below:

$$p ( d = i \vert x ) = \frac{p ( d = i , x )}{p ( x )} = p ( x \vert d = i ) p ( d = i ) / p ( x ) , \qquad Eq . 4$$

where p(x|d=i) follows the probability distribution function of the additive noise introduced by the wireless communication system, p(d=i) is the intrinsic probability that the source sends signal i, and p(x) is the probability of obtaining measurement x at the receiver. Normally, p(x) is neglected when using the likelihood ratio to make the decision.

Additive white Gaussian noise (AWGN) is the most basic model for estimating natural noise when designing receivers for wireless communication systems. Each of these modifiers denotes a different characteristic of the model. The term “additive” indicates it is added to any noise that might be intrinsic to the wireless communication system, the term “white” indicates that the noise has uniform power across the frequency band for the wireless communication system, and the term “Gaussian” indicates that the noise follows a normal distribution with an average time domain value of zero.

To improve the accuracy of AWGN, it is important to estimate the characteristics of this natural noise as accurately as possible. However, there are several factors that impair estimation. First, there tends to be an insufficient number of observations due to the limited number of reference signals. And second, there tends to be an imbalance at different frequencies introduced by interference.

In 4G and 5G broadband cellular networks, reference signals occupy a portion of the total bandwidth in order to reduce overhead. For example, the coded data carried along the physical downlink shared channel (PDSCH) in 5G broadband cellular networks is transmitted in combination with a demodulation reference signal (DMRS) that uses the same precoding and antenna ports. This ensures that user equipment (UE) can compare the received DMRS with the transmitted DMRS to deduce the propagation channel and noise distribution. The 5G technology standard describes two PDSCH-DMRS configurations.

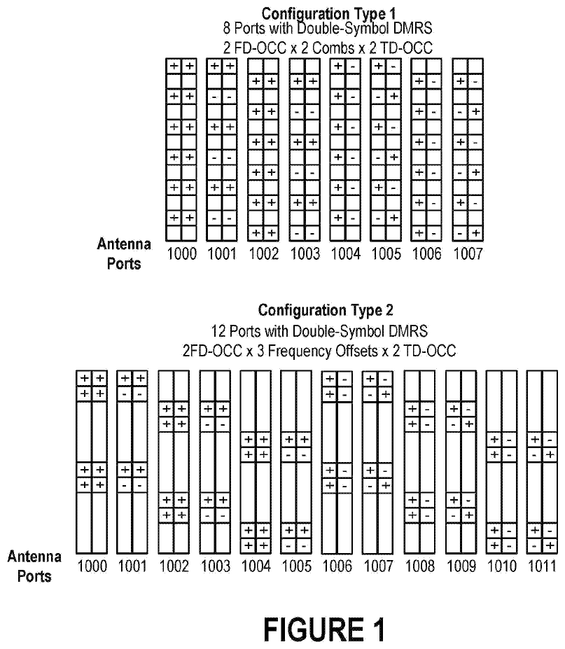

FIG. 1 includes a high-level diagram that illustrates the two PDSCH-DMRS configurations within a resource block (RB). The first configuration (referred to as a “type one configuration”) uses 50 percent of the resource elements of a symbol that is allocated to the DMRS (e.g., 6 resource elements per antenna port per RB), while the second configuration (referred to as a “type two configuration”) uses 33 percent of the resource elements of a symbol that is allocated to the DMRS (e.g., 4 resource elements per antenna port per RB).

To obtain the raw noise covariance, the estimated noise covariance can be averaged within the RB. The resulting metric may be referred to as “per-RB noise covariance.” However, in both configurations, the number of samples within an RB is not large enough to provide an accurate estimation of the noise covariance. For that reason, it is desirable to combine the samples from multiple RBs to improve the accuracy of estimation. In a live broadband cellular network, however, there may be interference from other sources on some frequencies in the channel of interest. This interference will pollute the DMRS (and thus, at least some of the samples) that could be used to eliminate or inhibit characteristics of the Gaussian noise.

Ideally, the per-RB noise covariance should be averaged over the allocated bandwidth to improve the accuracy of noise estimation. However, due to dynamic interference from the environment, different RBs within the allocated bandwidth may suffer from interference to varying degrees. For example, some RBs may experience moderate interference while other RBs may not experience any interference. Moreover, the inference in different RBs could also be different. Because the interference is fairly dynamic, it is impractical to estimate per-RB noise covariance using large window sizes.

Introduced here, therefore, are approaches in which the estimated noise covariance is estimated across multiple RBs that have similar noise distributions (or simply “distributions”). At a high level, these approaches use a sliding window to calculate covariance (e.g., to statistically determine whether noise distribution between consecutive RBs is similar) and then define clusters of RBs accordingly. The average covariance can then be calculated for each cluster, and each RB included in a cluster can be represented by the average covariance calculated for that cluster. This approach to establishing covariance based on analysis of multiple RBs rather than a single RB may be helpful for subsequent detection and/or modulation. Thus, the average covariance may be inserted into Eq. 4 to improve the accuracy of probabilistically determining the likelihood that a receiver will detect a signal.

These approaches result in more accurate noise estimation, as accuracy can be improved by increasing the sample size while also identifying and then eliminating contamination caused by interference. Said another way, the present disclosure introduces an automated approach to detecting imbalance between the RBs with pure noise and the RBs with interference and then forming clusters of RBs with similar characteristics to provide more samples that can be used in estimating noise covariance.

As further discussed below, an algorithm may be applied to a series of RBs in order to detect those that are contaminated with interference. This series of RBs may be representative of a “window” of RBs that is under examination. Then, the series of RBs may be filtered such that the contaminated RBs are removed. Noise covariance can then be estimated based on the filtered series of RBs to ensure that the impact of interference is minimized. For those RBs that are determined to include interference, there are several ways to estimate their covariance in practice. For example, a minimum averaging window size can be applied, or a dynamic window size can be further determined based on the interference characteristics.

As will become evident from a review of the present disclosure, the technology has been designed with performance, efficiency, and practicality in mind. For example, the technology can be readily implemented in modem chips that are designed to facilitate communication over 4G and 5G broadband cellular networks. The term “modem chip” refers to an integrated circuit that is configured to modulate signals in a way that encodes data to be transmitted to another modem and/or decodes data that is received from another modem. Note, however, that while embodiments may be described in the context of a particular wireless communication system, those skilled in the art will recognize that the features may be similarly applicable to other wireless communication systems.

Embodiments may be described with reference to particular computing devices, channels, etc. However, those skilled in the art will recognize that these features are similarly applicable to other computing devices, channels, etc. For example, while embodiments may be described in the context of estimating the noise experienced by a modem, features of those embodiments could be extended to other types of computing devices. As an example, the approach introduced here may be implemented by any computing device that includes a receiver able to handle traffic received over 4G and 5G broadband cellular networks.

Aspects of the technology can be embodied using hardware, firmware, software, or any combination thereof. Accordingly, embodiments may include a machine-readable medium with instructions that, when executed by a processor, cause the processor to perform a process in which the noise experienced by a wireless communication system is calculated by identifying the type of each resource block under consideration, clustering resource blocks of the same type, and then determining average noise covariance of each cluster of resource blocks.

### Terminology

References in this description to “an embodiment,” “one embodiment,” and “some embodiments” means that the feature, function, structure, or characteristic being described is included in at least one embodiment. Occurrences of such phrases do not necessarily refer to the same embodiments, nor are they necessarily referring to alternative embodiments that are mutually exclusive of one another.

Unless the context clearly requires otherwise, the words “comprise,” “comprising,” and “comprised of” are to be construed in an inclusive sense rather than an exclusive or exhaustive sense (i.e., in the sense of “including but not limited to”). The term “based on” is also to be construed in an inclusive sense rather than an exclusive or exhaustive sense. Thus, unless otherwise noted, the term “based on” is intended to mean “based at least in part on.”

The terms “connected,” “coupled,” or any variant thereof is intended to include any connection or coupling between two or more elements, either direct or indirect. The connection/coupling can be physical, logical, or a combination thereof. For example, objects may be electrically or communicatively coupled to one another despite not sharing a physical connection.

When used in reference to a list of multiple items, the word “or” is intended to cover all of the following interpretations: any of the items in the list, all of the items in the list, and any combination of items in the list.

The sequences of steps performed in the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

### Overview of Noise Estimation Scheme

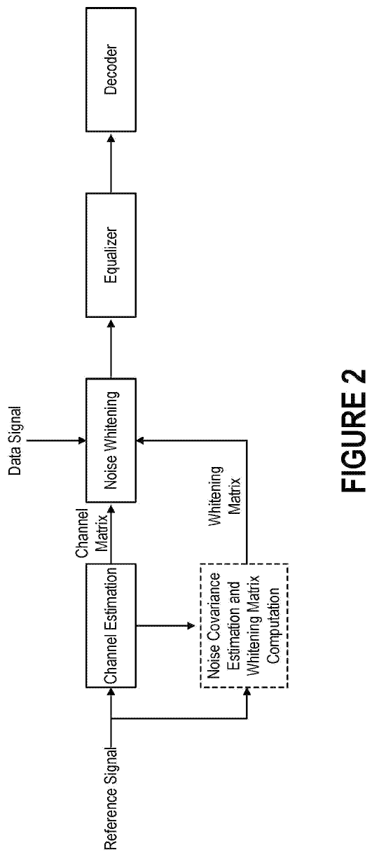

In wireless communication systems, estimating noise covariance is an essential step when performing noise whitening transformation of a data signal and estimated channel matrix before equalizing and decoding. FIG. 2 includes a high-level illustration of the workflow implemented by a receiver of a wireless communication system. In the physical traffic channels of 4G and 5G broadband cellular networks, reference signals are embedded inside the RBs across the channel bandwidth for the receiver to estimate both the channel and the noise from the reference signal. Then, a whitening matrix can be obtained from the noise covariance, for example, by applying inverse Cholesky decomposition of the noise covariance.

To obtain the raw noise covariance for a wireless communication system, the estimated noise covariance can be averaged within the RBs under examination. However, because the number of samples within an RB is not large enough to provide an accurate estimation of the noise covariance, it is desirable to combine the samples from multiple RBs to improve the accuracy of estimation.

Historically, entities have attempted to address the insufficient number of samples by simply combining a fixed number of resource elements (REs) from a predetermined number of RBs to increase the number of observations for noise estimation purposes. However, due to the existence of interference, the number of RBs cannot be very large. Otherwise, the interference will be counted in the observations (and thus cause errors when estimating the noise). In practice, only two to four RBs are normally combined to account for the tradeoff between the accuracy of noise estimation and the chance of experiencing an error due to interference.

The approach introduced here addresses this issue by allowing RBs of the same type to be clustered together without restrictions on the size of those clusters. Rather than use a fixed number of RBs for noise estimation purposes, the approach involves detecting the RBs that are affected by interference (and thus will cause an abrupt change in distribution characteristics of the covariance matrices of the RBs) and then remove those RBs from consideration.

Note that the approach may be implemented in a demodulator module as hardware, firmware, or software. For example, the demodulator module may implement the approach through execution of computer-readable instructions. As another example, the demodulator module may provide, as input, information to an integrated circuit that is designed to implement the approach. As further discussed below, this information may include the covariance matrix of each RB under examination that is generated by a channel estimation module (also referred to as a “channel estimator”). The demodulator module may produce, as output, another covariance matrix for each RB following the clustering and averaging processing discussed below. The integrated circuit may be, for example, an application-specific integrated circuit (ASIC) or field-programmable gate array (FPGA). Meanwhile, the demodulator module and channel estimator may be included in a computing device, such as a modem, that includes a wireless communication system.

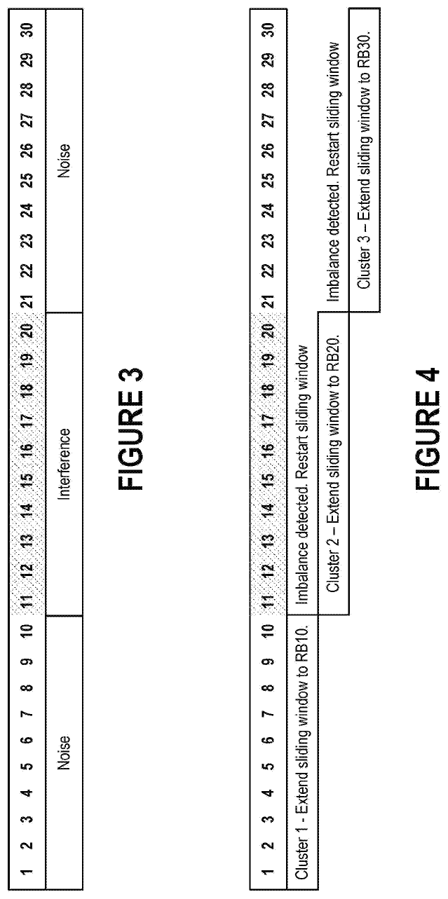

FIG. 3 illustrates how interference may occur in the middle of bandwidth of a channel. Here, the channel is the PDSCH channel. There are 30 RBs in the PDSCH channel as shown in FIG. 3, and, in this example, the central 10 RBs (i.e., RB11-20) are affected by interference. At a high level, the approach introduced here allows the abrupt change in noise and interference distribution to be detected, so that the 30 RBs can be segmented into clusters, namely, an “interference” cluster of RBs interposed between a pair of “noise” clusters. The covariance matrix can then be averaged within each cluster to improve the estimation with more samples (also referred to as “observations”). Note that the term “noise cluster” refers to a cluster of one or more RBs whose distributions indicate roughly pure noise. Meanwhile, the term “interference cluster” refers to a cluster of one or more RBs whose distributions indicate interference in addition to noise.

To begin, a demodulator module may initialize a sliding window to start at the first RB that occupies bandwidth of a given channel. Then, the demodulator module may define the size of the sliding window to be m RBs, where m is a predefined parameter with a default value. Thereafter, the demodulator module can calculate average covariance of the noise of the RBs contained within the sliding window. The average covariance can then be compared with the average covariance of the noise of the next n RBs that occupy bandwidth of the given channel, where n is a predefined parameter with a default value, so as to produce a distance metric. At a high level, the distance metric is representative of similarity between these average covariance values.

If the distance metric exceeds a threshold—meaning there is a significant probability that the next n RBs have different distribution characteristics than the m RBs contained in the sliding window—then the demodulator module can mark those RBs contained in the sliding window as belonging to a cluster. As further discussed below. each RB in the cluster may be represented by the average covariance of the cluster as a whole. Then, the demodulator module can reinitialize the sliding window to start at the next RB, namely, the first RB of the next n RBs. However, if the distance does not exceed the threshold, then the demodulator module can extend the sliding window such that it includes the next n RBs. The above-mentioned steps can be performed until all RBs that occupy bandwidth of the given channel have been assigned to a cluster. Note that each cluster may have a minimum size of m RBs, since that is the minimum size for defining the sliding window.

After this process is complete, the demodulator module may output a list of RBs occupying bandwidth of the given channel. For each RB, the list may specify the corresponding cluster and/or average covariance. This information may be stored by the demodulator module in a memory for subsequent use.

Assume, for example, that the default value of m is two while the default value of n is one. In such a scenario, the demodulator module will initialize the sliding window such that it contains RB1 and RB2 as shown in FIG. 3. The demodulator module will then calculate the average covariance of RB1 and RB2 and then compare the average covariance to covariance of RB3. If those covariance values are similar to one another, then the sliding window can be extended such that it contains RB1, RB2, and RB3. However, if those covariance values are dissimilar from one another, then the sliding window can be reinitialized such that it contains RB3 and RB4. In that situation, RB1 and RB2 can be defined as a cluster of RBs of the same type. Note that these default values of m and n have been provided for the purpose of illustration. Those skilled in the art will recognize that the default values of m and n could be any value.

Another example of this process is shown in FIG. 4, where imbalance in interference has caused the RBs to be sorted into three clusters.

The distance metric and threshold in this context may be predetermined based on, for example, the noise and interference statistics in order to optimize the accuracy of detecting interference over calculation complexity for a target interference-to-noise ratio. For example, candidate distance metrics include the following:
K-L divergence may be used to convey similarity between two distributions if the noise per RB is zero mean with covariance matrix Σ;
Chi-square test may be used if the noise on different antennas and different RBs can be modeled as independent and identically distributed random variables having a normal distribution; and
Exponential distribution may be used on a per-antenna basis if the noise can be modeled as independent and identically distributed random variables having a normal distribution on each antenna separately.

This approach—in which RBs having comparable amounts of interference are clustered together—results in several notable benefits. As an example, clustering RBs allows for more samples to be taken into account when estimating the noise in a given RB. Rather than rely on the noise in a single RB, estimation can be improved by observing the noise across multiple RBs that have similar distributions, while still avoiding errors that could be introduced by imbalanced distributions. More accurate estimation of the noise will ultimately result in improvements in performance of the receiver. This is especially beneficial for wideband data channels, such as those in 4G and 5G broadband cellular networks, when spur interference is often expected on certain frequencies within the bandwidth of certain channels.

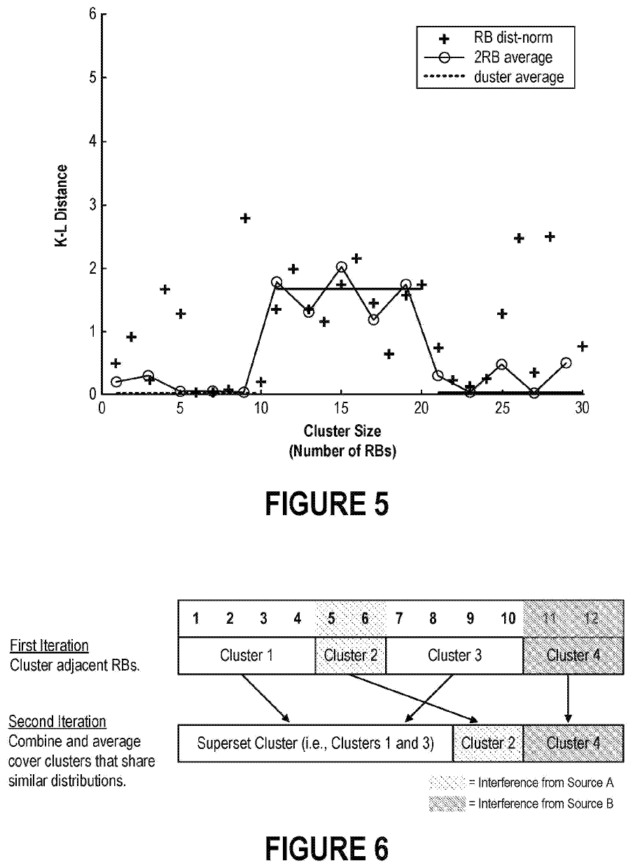

FIG. 5 illustrates the benefits of the approach introduced here through a simulation using the example channels shown in FIGS. 3-4. In FIG. 5, crosses indicate the K-L divergence between per-RB covariance and genie noise covariance, while circles indicate the K-L divergence between 2-RB average covariance and genie noise covariance. The line segments are representative of the clusters and the corresponding K-L divergence between the cluster average covariance and genie noise covariance. Per the simulation, the cluster average covariance has much smaller divergence (e.g., close to zero for a cluster with a size of 10 RBs) from the genie noise covariance in comparison to the 2-RB average covariance and per-RB covariance.

When implemented, the approach introduced here will result in adjacent RBs being sorted into clusters for which average covariance can be calculated. Based on statistical theory, the sample size (N) that is required for the estimation error to be less than δ=0.5σ with a probability of 90 percent is 35. This translates to 6 RBs for a type one configuration and 9 RBs for a type two configuration.

It may be the case that after performing the approach, at least some of the clusters will be smaller than the minimum size required to meet this performance target. As such, it may be desirable to perform multiple iterations of the approach to further combine those clusters that share a similar distribution. FIG. 6 demonstrates how the RBs included in a channel may be sorted into four clusters following a first iteration of the approach. These four clusters may include two noise clusters, each with four RBs, and two interference clusters, each with two RBs. Following the second iteration of the approach, the average noise covariances of the first and third clusters can be further combined since those clusters share a similar distribution. Because the second and fourth clusters experience interference from different sources, those clusters may not be combined into a superset cluster.

### Methodologies for Distinguishing RBs Having Dissimilar Noise Distributions

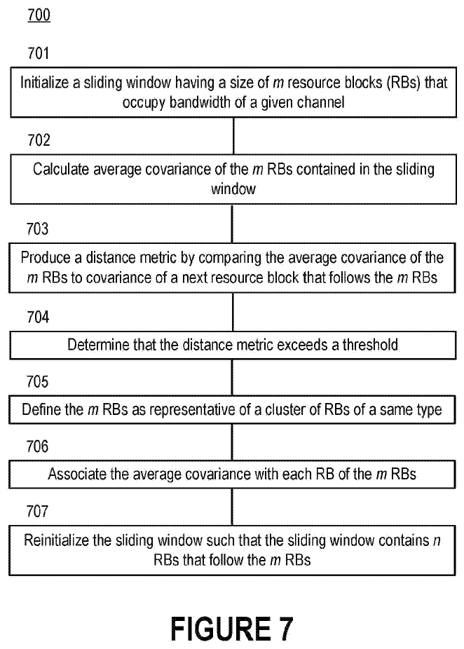

FIG. 7 depicts a flow diagram of a process 700 for distinguishing RBs having dissimilar noise distributions. Initially, a demodulation module initializes a sliding window that has a size of m RBs that occupy bandwidth of a given channel (step 701). For example, the demodulation module may initialize the sliding window to begin at the first RB that occupies bandwidth of the given channel. While the value of m is normally at least two, m may have a value of one in some embodiments. Note that the bandwidth occupied by each RB may be based on the spacing configuration of the subcarriers occupied by the RBs of the given channel. The number of RBs associated with the given channel may be based on the network technology (e.g., 4G or 5G) for which the given channel is designed and configured.

Then, the demodulation module can calculate the average covariance of the noise in the m RBs contained in the sliding window (step 702). Covariance is a measure of the joint variability of two random variables. The random variables may be, for example, the noise in a first RB and the noise in a second RB. If greater values of one random variable largely correspond to greater values of the other random variable, and the same holds true for the lesser values, then the covariance is positive. Conversely, when greater values of one random variable mainly correspond to lesser values of the other random variable, then the covariance is negative. As further discussed below, the demodulator module may determine whether to expand or reinitialize the sliding window based on a threshold that is representative of, or based on, covariance.

Thereafter, the demodulator module can produce a distance metric by comparing the average covariance of the m RBs to covariance of the next RB that follows the m RBs (step 703). Note that, in some embodiments, the demodulator module is configured to compare the average covariance of the m RBs to the average covariance of the next n RBs, where n is a value of at least two. Thus, the demodulator module may compare the m RBs to one or more RBs in terms of noise distribution.

The demodulator module can then compare the distance metric to a threshold. This threshold may be programmed in memory of the computing device of which the demodulator module is a part. Moreover, this threshold may be based on the given channel. If the distance metric does not exceed the threshold, then the demodulator module can infer that the next RB has a similar noise distribution as the m RBs. In such a scenario, the demodulator module can expand the sliding window to include the next RB in addition to the m RBs.

However, if the demodulator module determines that the distance metric does exceed the threshold (step 704), then the demodulator module can define the m RBs as representative of a cluster of RBs of the same type (step 705). Said another way, the demodulator module can define the m RBs as representative of a cluster of RBs that have comparable noise distributions. As discussed above, there are two “types” of RBs, namely, those with pure noise and those with interference and noise. Thus, the cluster of RBs may be affected by interference while the next RB is not affected by interference, or the cluster of RBs may not be affected by interference while the next RB is affected by interference.

The demodulator module can then associate the average covariance with each RB of the m RBs (step 706). For example, the demodulator module may indicate in a data structure that the average covariance is representative of each RB of the m RBs. The data structure may include a separate entry for each RB of the given channel, and each entry associated with one of the m RBs may be populated with the average covariance.

Moreover, the demodulator module can reinitialize the sliding window such that the sliding window contains n RBs that follow the m RBs (step 707). That is, the demodulator module may reinitialize the sliding window, beginning with the next resource block, so that the process 700 can be performed again. As discussed above, the process 700 may be performed repeatedly until all RBs occupying bandwidth in the given channel have been assigned to a cluster.

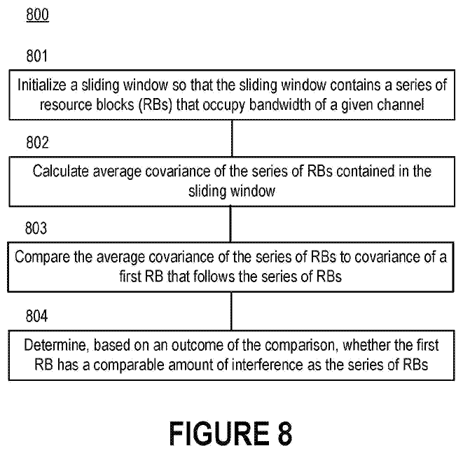

FIG. 8 depicts a flow diagram of another process 800 for sorting RBs include clusters based on the amount of interference contained therein. Initially, a demodulator module can initialize a sliding window so that the sliding window contains a series of RBs that occupy bandwidth of a given channel (step 801). Step 801 of FIG. 8 may be substantially similar to step 701 of FIG. 7. The given channel may be, for example, a physical channel defined in accordance with the 5G New Radio (NR) standard. The demodulator module can then calculate the average covariance of the series of RBs contained in the sliding window (step 802). Step 802 of FIG. 8 may be substantially similar to step 702 of FIG. 7.

The average covariance of the series of RBs can then be compared to covariance of a first RB that follows the series of RBs (step 803). As discussed above, in some embodiments, the first RB is part of a second series of RBs to which the series of RBs is compared. Thus, the demodulator module may be configured to compare average covariance of the series of RBs to average covariance of the second series of RBs of which the first RB is a part. The demodulator module may determine, based on an outcome of the comparison, whether the first RB has a comparable amount of interference as the series of RBs (step 804).

In some embodiments, performing step 803 results in a distance metric being produced that is indicative of similarity in terms of interference in the series of RBs and interference in the first RB. If the demodulator module determines that the distance metric exceeds a threshold, then the demodulator module may define the series of RBs as representative of a cluster of RBs having a comparable amount of interference. However, if the demodulator module determines that the distance metric does not exceed the threshold, then the demodulator module may expand the sliding window so that the sliding window contains the series of RBs and the first RB.

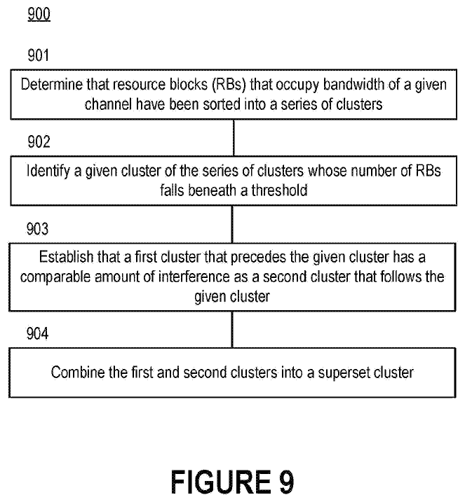

FIG. 9 depicts a flow diagram of a process 900 for combining non-adjacent clusters of RBs having comparable noise distributions. Initially, a demodulation module may determine that RBs that occupy bandwidth of a given channel have been sorted into a series of clusters (step 901). For example, the series of clusters may have been established by repeatedly performing either the process of FIG. 7 or the process of FIG. 8 until all RBs of the given channel have been assigned to a cluster. Each cluster includes one or more RBs that have a comparable amount of interference. Thus, all of the RBs in each cluster will have similar noise distributions.

The demodulation module can then identify a given cluster of the series of clusters whose number of RBs falls beneath a threshold (step 902). The threshold may be representative of a static value that is programmed in memory of the computing device of which the demodulation module is a part. At a high level, the threshold may be indicative of the minimum number of RBs that should be included in each cluster. Thereafter, the demodulation module can establish that a first cluster that precedes the given cluster has a comparable amount of interference as a second cluster that follows the given cluster (step 903). This may be accomplished by comparing the average covariance of the first cluster to the average covariance of the second cluster. In such a scenario, the demodulation module can combine the first and second clusters into a superset cluster so long as the interference in the first and second clusters comes from the same source. More specifically, the demodulation module can compute a covariance metric based on the average covariance of the first cluster and the average covariance of the second cluster and then associate the covariance metric with each RB included in the first and second clusters. If the interference in the first cluster comes from a different source than the interference in the second cluster, then the demodulation module may refrain from combining the first and second clusters together.

When implemented, this approach to combining non-adjacent clusters may cause the number of clusters created for the given channel to be lessened without filtering any RBs. As mentioned above, the process 900 of FIG. 9 may be implemented in order to increase the number of samples available for noise estimation purposes. As such, if a minimum number of samples has been defined, then the demodulation module may repeatedly perform the process 900 until the superset cluster includes at least a predetermined number of RBs.

Note that while the processes of FIGS. 7-9 are discussed in the context of a demodulation module, the processes could be performed by another processing component of a computing device. For example, a channel status feedback module can also use the noise covariance generated from the same process. More generally, the process may be applicable to any module that needs to perform noise whitening. The process can be implemented in specifically designed hardware, or the process can be implemented in software running on a general purpose processor. Whether the process is implemented in hardware or software may depend on the design limitations in delay and power.

The steps of these processes may be performed in various combinations and sequences. For example, the processes of FIGS. 7-8 may be performed repeatedly until all RBs that occupy bandwidth of the channel under examination have been assigned to a cluster. Other steps may also be included in some embodiments. For example, the demodulator module may be configured to output a list of RBs that occupy bandwidth of the channel under examination. This list may specify, for each RB, a covariance value that is representative of the average covariance calculated for the corresponding cluster. Additionally or alternatively, this list may specify the cluster to which each RB has been assigned.

### Computing System

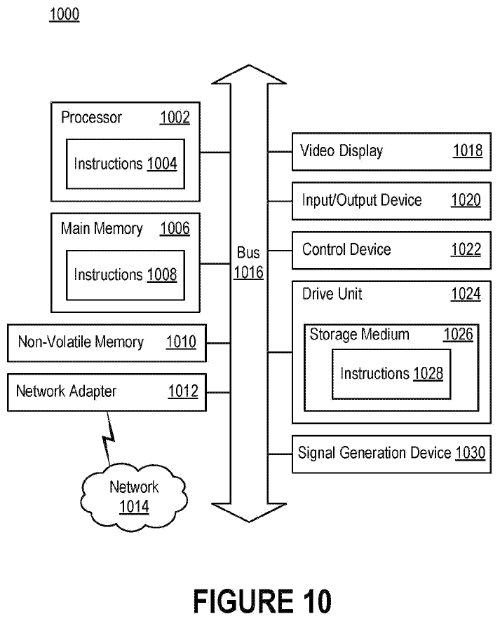

FIG. 10 includes a high-level block diagram that illustrates an example of a computing system 1000 that may implement the processes described herein. Thus, components of the computing system 1000 may be hosted on a computing device that includes a processing component (e.g., a demodulation module) operable to perform the processes described herein.

The computing system 1000 may include a processor 1002, main memory 1006, non-volatile memory 1010, network adapter 1012, video display 1018, input/output device 1020, control device 1022 (e.g., a keyboard, pointing device, or mechanical input such as a button), drive unit 1024 that includes a storage medium 1026, and signal generation device 1030 that are communicatively connected to a bus 1016. The bus 1016 is illustrated as an abstraction that represents one or more physical buses and/or point-to-point connections that are connected by appropriate bridges, adapters, or controllers. The bus 1016, therefore, can include a system bus, Peripheral Component Interconnect (PCI) bus, PCI-Express bus, HyperTransport bus, Industry Standard Architecture (ISA) bus, Small Computer System Interface (SCSI) bus, Universal Serial Bus (USB), Inter-Integrated Circuit (I²C) bus, or bus compliant with Institute of Electrical and Electronics Engineers (IEEE) Standard 1394.

The computing system 1000 may share a similar computer processor architecture as that of a server, router, desktop computer, tablet computer, mobile phone, video game console, wearable electronic device (e.g., a watch or fitness tracker), network-connected (“smart”) device (e.g., a television or home assistant device), augmented or virtual reality system (e.g., a head-mounted display), or another electronic device capable of executing a set of instructions (sequential or otherwise) that specify action(s) to be taken by the computing system 1000.

While the main memory 1006, non-volatile memory 1010, and storage medium 1024 are shown to be a single medium, the terms “storage medium” and “machine-readable medium” should be taken to include a single medium or multiple media that stores one or more sets of instructions 1026. The terms “storage medium” and “machine-readable medium” should also be taken to include any medium that is capable of storing, encoding, or carrying a set of instructions for execution by the computing system 1000.

In general, the routines executed to implement the embodiments of the present disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memories and storage devices in a computing device. When read and executed by the processor 1002, the instructions cause the computing system 1000 to perform operations to execute various aspects of the present disclosure.

While embodiments have been described in the context of fully functioning computing devices, those skilled in the art will appreciate that the various embodiments are capable of being distributed as a program product in a variety of forms. The present disclosure applies regardless of the particular type of machine- or computer-readable medium used to actually cause the distribution. Further examples of machine- and computer-readable media include recordable-type media such as volatile and non-volatile memory devices 1010, removable disks, hard disk drives, optical disks (e.g., Compact Disk Read-Only Memory (CD-ROMS) and Digital Versatile Disks (DVDs)), cloud-based storage, and transmission-type media such as digital and analog communication links.

The network adapter 1012 enables the computing system 1000 to mediate data in a network 1014 with an entity that is external to the computing system 1000 through any communication protocol supported by the computing system 1000 and the external entity. The network adapter 1012 can include a network adaptor card, a wireless network interface card, a switch, a protocol converter, a gateway, a bridge, a hub, a receiver, a repeater, or a transceiver that includes an integrated circuit (e.g., enabling communication over Bluetooth® or Wi-Fi®).

The techniques introduced here can be implemented using software, firmware, hardware, or a combination of such forms. For example, aspects of the present disclosure may be implemented using special-purpose hardwired (i.e., non-programmable) circuitry in the form of application-specific integrated circuits (ASICs), programmable logic devices (PLDs), field-programmable gate arrays (FPGAs), and the like.

In accordance with some aspects of the present disclosure, a method for distinguishing resource blocks having dissimilar noise distributions is provided. The method includes initializing a sliding window having a size of m resource blocks that occupy bandwidth of a given channel. “m” is a value of at least two. The method also includes calculating average covariance of noise in the m resource blocks contained in the sliding window, producing a distance metric by comparing the average covariance of the m resource blocks to covariance of noise in a next resource block that follows the m resource blocks, determining that the distance metric exceeds a threshold, defining, in response to said determining, the m resource blocks as representative of a cluster of resource blocks having comparable noise distributions, and associating the average covariance with each resource block of the m resource blocks.

In accordance with some other aspects of the present disclosure, a non-transitory computer-readable medium with instructions that, when executed by a processor of a computing device, cause the computing device to perform operations includes initializing a sliding window so that the sliding window contains a series of resource blocks that occupy bandwidth of a given channel, calculating average covariance of noise in the series of resource blocks contained in the sliding window, comparing the average covariance of the series of resource blocks to covariance of noise in a first resource block that follows the series of resource blocks, and determining, based on an outcome of said comparing, whether the first resource block has a comparable amount of interference as the series of resource blocks.

The foregoing description of various embodiments has been provided for the purposes of illustration. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes various embodiments, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for distinguishing resource blocks having dissimilar noise distributions, the method comprising:
initializing a sliding window having a size of m resource blocks that occupy bandwidth of a given channel, m being a value of at least two;
calculating average covariance of noise in the m resource blocks contained in the sliding window;
producing a distance metric by comparing the average covariance of the m resource blocks to covariance of noise in a next resource block that follows the m resource blocks;
determining that the distance metric exceeds a threshold;
defining, in response to said determining, the m resource blocks as representative of a cluster of resource blocks having comparable noise distributions; and
associating the average covariance with each resource block of the m resource blocks.

2. The method of claim 1, further comprising:
reinitializing, responsive to said determining, the sliding window such that the sliding window contains n resource blocks that follow the m resource blocks, n being a value of at least two,
wherein the next resource block is the first resource block in the n resource blocks.

3. The method of claim 1, wherein the threshold is based on the given channel.

4. The method of claim 1, wherein the bandwidth occupied by each resource block is based on spacing configuration of subcarriers occupied by the resource blocks of the given channel.

5. The method of claim 1, wherein said determining indicates that the next resource block is a different type from the series of resource blocks.

6. The method of claim 5, wherein each resource block in the series of resource blocks is affected by interference while the next resource block is not affected by interference.

7. The method of claim 5, wherein each resource block in the series of resource blocks is not affected by interference while the next resource block is affected by interference.

8. The method of claim 1, wherein said associating comprises:
indicating in a data structure that the average covariance is representative of each resource block of the m resource blocks,
wherein the data structure includes an entry for each resource block of the given channel, and
wherein each entry associated with one of the m resource blocks is populated with the average covariance.

9. A non-transitory computer-readable medium with instructions that, when executed by a processor of a computing device, cause the computing device to perform operations comprising:
initializing a sliding window so that the sliding window contains a series of resource blocks that occupy bandwidth of a given channel;
calculating average covariance of noise in the series of resource blocks contained in the sliding window;
comparing the average covariance of the series of resource blocks to covariance of noise in a first resource block that follows the series of resource blocks; and
determining, based on an outcome of said comparing, whether the first resource block has a comparable amount of interference as the series of resource blocks.

10. The non-transitory computer-readable medium of claim 9, wherein the given channel is a physical channel defined in accordance with the 5G New Radio (NR) standard.

11. The non-transitory computer-readable medium of claim 9,
wherein said comparing results in a distance metric being produced that is indicative of similarity in terms of interference in the series of resource blocks and interference in the first resource block, and
wherein said determining comprises:
establishing that the distance metric exceeds a threshold, and
defining the series of resource blocks as representative of a cluster of resource blocks having a comparable amount of interference.

12. The non-transitory computer-readable medium of claim 11, further comprising:
associating the average covariance with each resource block in the series of resource blocks.

13. The non-transitory computer-readable medium of claim 9,
wherein said comparing results in a distance metric being produced that is indicative of similarity in terms of interference in the series of resource and interference in the first resource block, and
wherein said determining comprises:
establishing that the distance metric does not exceed a threshold, and
expanding the sliding window so that the sliding window contains the series of resource blocks and the first resource block.

14. The non-transitory computer-readable medium of claim 13,
wherein the series of resource blocks and the first resource block are representative of a second series of resource blocks, and
wherein the operations further comprise:
calculating average covariance of the second series of resource blocks contained in the expanded sliding window;
comparing the average covariance of the second series of resource blocks to covariance of a second resource block that follows the second series of resource blocks; and
determining, based on an outcome of said comparing, whether the second resource block has a comparable amount of interference as the second series of resource blocks.

15. The non-transitory computer-readable medium of claim 14,
wherein the operations are performed repeatedly until all resource blocks that occupy bandwidth of the given channel are assigned to a cluster of resource blocks having a comparable amount of interference, and
wherein each cluster of resource blocks includes at least one resource block.

16. The non-transitory computer-readable medium of claim 15, wherein the operations further comprise:
outputting a list of all resource blocks that occupy bandwidth of the given channel,
wherein the list specifies, for each resource block, a covariance value that is representative of the average covariance calculated for the corresponding cluster of resource blocks.

17. A method comprising:
determining that resource blocks that occupy bandwidth of a given channel have been sorted into a series of clusters,
wherein each cluster includes at least one resource block, and
wherein the at least one resource block included in each cluster has a comparable amount of interference;
identifying a given cluster of the series of clusters whose number of resource blocks falls beneath a threshold;
establishing that a first cluster that precedes the given cluster has a comparable amount of interference from a same source as a second cluster that follows the given cluster;
combining the first and second clusters into a superset cluster by
computing a covariance metric based on average covariance of the first cluster and average covariance of the second cluster; and
associating the covariance metric with each resource block included in the first and second clusters.

18. The method of claim 17, wherein said combining causes a number of clusters to be lessened without filtering any resource blocks.

19. The method of claim 17, wherein said establishing is based on a comparison of the average covariance of the first cluster and the average covariance of the second cluster.

20. The method of claim 17, wherein said identifying, said establishing, and said combining are performed repeatedly until the superset cluster includes at least a predetermined number of resource blocks.
